(19) United States
(12) Patent Application Publication
(10) Pub. No.: US 2019/0070845 A1
(43) Pub. Date: Mar. 7, 2019

(54) APPARATUSES, SYSTEMS AND METHOD FOR GENERATING THREE-DIMENSIONAL OBJECTS WITH ADJUSTABLE PROPERTIES

(71) Applicant: San Draw Inc., San Jose, CA (US)

(72) Inventors: Kai-Jui Chang, New York, NY (US); Shao-Chun Lu, San Jose, CA (US)

(21) Appl. No.: 16/120,092

(22) Filed: Aug. 31, 2018

Related U.S. Application Data
(63) Continuation of application No. PCT/US2017/021829, filed on Mar. 10, 2017.
(60) Provisional application No. 62/306,088, filed on Mar. 10, 2016.

(51) Int. Cl. B33Y 80/00; B33Y 70/00; B29C 64/124; G06F 17/50; B29C 64/209; B33Y 10/00

(52) U.S. Cl. CPC B33Y 80/00; B33Y 70/00; B33Y 10/00; G06F 17/5009; B29C 64/209; B29C 64/124

(57) ABSTRACT

The present disclosure provides systems and methods for the formation of three-dimensional objects. Substrates of the present disclosure may be formed using the materials, processes, methods, and systems described herein.

### CROSS-REFERENCE

This application is a continuation application of International Patent Application No. PCT/US2017/021829, filed on Mar. 10, 2017, which claims priority to U.S. Provisional Patent Application Ser. No. 62/306,088, filed Mar. 10, 2016, each of which is entirely incorporated herein by reference.

### BACKGROUND

Three-dimensional printing (3D printing) is a process for making three-dimensional objects of various shapes and sizes. The three-dimensional objects may be formed based on a model design. A model design may be formed via a computer, a drawing, or be based on another object.

Different materials may be used in three-dimensional printing, including silicon, silicone rubber, siliconized acrylic caulk, polyurethane, and curable resin. Three-dimensional printing may efficiently form objects that may be difficult to make via traditional methods.

### SUMMARY

While three-dimensional (3D) printing systems and methods are available, recognized herein are various issues with certain 3D printing systems and methods. For example, 3D printing systems and methods may not enable the printing of 3D objects with adjustable properties, such as material compositions, color gradients, density, and hardness. Methods and systems provided herein advantageously enable the formation of 3D objects with adjustable properties.

In an aspect, the present disclosure provides a method for forming a three-dimensional object, comprising: (a) providing at least two material cartridges that are in fluid communication with a mixer that is in fluid communication with a nozzle of a print head, wherein the at least two material cartridges contain building materials; (b) using building materials from the at least two material cartridges to generate a first mixture in the mixer; (c) directing the first mixture from the mixer through the nozzle towards a support to form a first layer of the three-dimensional object adjacent to the support, wherein the first layer comprises a first perimeter and a first subsection of area within the first perimeter; (d) using building materials from the at least two material cartridges to generate a second mixture in the mixer; and (e) directing the second mixture from the mixer through the nozzle towards the support to form a second layer of the three-dimensional object adjacent to the support, wherein the second layer comprises a second perimeter and a second subsection of area within the second perimeter, wherein at least a portion of the second subsection is adjacent to at least a portion of the first subsection.

In some embodiments, the method further comprises repeating (d)-(e) at least 10 times. In some embodiments, the method further comprises repeating (d)-(e) at least 100 times. In some embodiments, the method further comprises repeating (d)-(e) at least 200 times. In some embodiments, the mixer is a channel In some embodiments, the first subsection is less than 99% of an area enclosed by the first perimeter. In some embodiments, the first subsection is less than 90% of an area enclosed by the first perimeter. In some embodiments, the first subsection is less than 75% of an area enclosed by the first perimeter. In some embodiments, the at least two material cartridges comprise building materials that are of a first color and a second color, and wherein the first mixture is of a third color different than the first color and the second color. In some embodiments, the d first color is different than the second color.

In some embodiments, at least one of the building materials comprises silicone, silicone rubber, polyurethane, fluoroelastomer, acrylic paste, an epoxy resin, or a combination thereof. In some embodiments, at least one of the building materials has a viscosity less than or equal to 10,000,000 centipoise (cP). In some embodiments, at least one of the building materials has a viscosity less than or equal to 1,000,000 cP. In some embodiments, at least one of the building materials has a viscosity less than or equal to 100,000 cP. In some embodiments, the first layer of the three-dimensional object has a thickness of at least 0.1 millimeters. In some embodiments, the first layer of the three-dimensional object material has a thickness of at least 0.2 millimeters. In some embodiments, the first layer of the three-dimensional object has a thickness of 0.1 millimeters to 100 millimeters.

In some embodiments, at least one of the building materials is in a liquid state. In some embodiments, the building materials are directed to the nozzle by mechanical force, pneumatic force, gravity, osmotic pressure difference, pressure difference, or a combination thereof. In some embodiments, the print head moves to the first subsection relative to the support. In some embodiments, the nozzle moves over the first subsection within the first perimeter without directing the building materials towards the support. In some embodiments, the three-dimensional object is anisotropic. In some embodiments, the three-dimensional object is isotropic.

In some embodiments, the first layer of the three-dimensional object and the second layer of the three-dimensional object have at least one physical property that is different. In some embodiments, the at least one physical property is fill density, tensile strength or color. In some embodiments, the first subsection is in accordance with a model design of the three-dimensional object. In some embodiments, the three-dimensional object is formed in a time period of less than 1 week. In some embodiments, the three-dimensional object is formed in a time period of less than 3 days. In some embodiments, the three-dimensional object is formed in a time period of less than 36 hours. In some embodiments, the three-dimensional object has dimensions of less than 10 m by 10 m by 10 m. In some embodiments, the three-dimensional object has dimensions of less than 1 m by 1 m by 1 m. In some embodiments, the three-dimensional object has dimensions of less than 0.5 m by 0.5 m by 0.5 m.

In some embodiments, the model design comprises at least 10 parallel cross-sections of the three-dimensional object. In some embodiments, the model design comprises at least 100 parallel cross-sections of the three-dimensional object. In some embodiments, at least one of the building materials comprises a polymer. In some embodiments, the first layer of the three-dimensional object and the second layer of the three-dimensional object have at least one physical property that is the same. In some embodiments, building materials of the at least two material cartridges have different parameters. In some embodiments, the different parameters include color or material composition.

In some embodiments, upon forming the second layer, a cross-section of the three-dimensional object is not 100% filled. In some embodiments, wherein along a cross-section, the three-dimensional object has multiple regions of different fill densities. In some embodiments, the three-dimensional object has a fill density that is isotropic. In some embodiments, the three-dimensional object has a fill density that is anisotropic. In some embodiments, the method further comprises filling a cavity of the three-dimensional object. In some embodiments, the cavity is filled at a fill rate that is selected to provide a predetermined physical property of the three-dimensional object. In some embodiments, the predetermined physical property is one or more of hardness, density, tensile strength and elongation-to-break.

In an aspect, the present disclosure provides a method for forming a three-dimensional object, comprising: (a) providing at least one material container that is in fluid communication with a nozzle of a print head, wherein the at least one material container includes at least one building material; (b) directing the at least one building material in a liquid state from the at least one material container through the nozzle towards a support to form a first portion of the three-dimensional object adjacent to the support, which first portion is formed upon solidification of the building material adjacent to the support, wherein the first portion includes a first physical property; and (c) directing the at least one building material in the liquid state from the at least one material container through the nozzle towards the support to form a second portion of the three-dimensional object adjacent to the first portion or the support, which second portion is formed upon solidification of the building material, wherein the second portion includes a second physical property that is different than the first physical property.

In some embodiments, the building material is a polymeric material. In some embodiments, the building material is solidified upon application of energy to the building material. In some embodiments, the polymeric material includes silicone, polyurethane, elastomer, or an epoxy. In some embodiments, the elastomer is a fluoroelastomer. In some embodiments, the method further comprises applying heat or electromagnetic energy to the building material to solidify the building material. In some embodiments, the electromagnetic energy is ultraviolet light.

In some embodiments, the method further comprises directing the at least one building material in the liquid state from the at least one material container through the nozzle towards the support to form a third portion of the three-dimensional object, which second portion is formed upon solidification of the building material. In some embodiments, the first portion and/or the second portion comprises one or more layers of the building material. In some embodiments, the first physical property or the second physical property is selected from the group consisting of fill density, tensile strength and color.

In an aspect, the present disclosure provides a method for forming a three-dimensional object, comprising (a) directing at least one building material from at least one material container in a liquid state through a nozzle of a print head towards a support, and (b) generating at least a portion of the three-dimensional object at variable fill density upon solidification of the at least one building material adjacent to the support.

In some embodiments, the method further comprises regulating a rate at which the building material is directed through the nozzle to regulate a fill density of the at least the portion of the three-dimensional object. In some embodiments, wherein across a given cross-section, the three-dimensional object is not completely filled.

In an aspect, the present disclosure provides a system for forming a three-dimensional object, comprising: a print head comprising a nozzle; a mixer in fluid communication with the nozzle; at least two material containers in fluid communication with the mixer, wherein the at least two material containers are configured to contain building materials; and a controller operatively coupled to the at least two material containers, wherein the controller is programmed to (i) use the building materials from the at least two material containers to generate a first mixture in the mixer; (ii) direct the first mixture from the mixer through the nozzle towards a support to form a first layer of the three-dimensional object adjacent to the support, wherein the first layer comprises a first perimeter and a first subsection of area within the first perimeter; (iii) use the building materials from the at least two material containers to generate a second mixture in the mixer; and (iv) direct the second mixture from the mixer through the nozzle towards the support to form a second layer of the three-dimensional object adjacent to the support, wherein the second layer comprises a second perimeter and a second subsection of area within the second perimeter, wherein at least a portion of the second subsection is adjacent to at least a portion of the first subsection.

In some embodiments, the mixer is a channel. In some embodiments, the mixer is a chamber. In some embodiments, the print head is configured to move to the first subsection relative to the support. In some embodiments, the nozzle is configured to move over the first subsection within the first perimeter without directing building material towards the support. In some embodiments, the at least two material containers are material cartridges.

In an aspect, the present disclosure provides a system for forming a three-dimensional object, comprising: a print head comprising a nozzle; at least one material container in fluid communication with the nozzle, wherein the at least one material container is configured to contain at least one building material; and a controller operatively coupled to the at least one material container, wherein the controller is programmed to: (i) direct the at least one building material in a liquid state from the at least one material container through the nozzle towards a support to form a first portion of the three-dimensional object adjacent to the support, which first portion is formed upon solidification of the building material adjacent to the support, wherein the first portion includes a first physical property; and (ii) direct the at least one building material in the liquid state from the at least one material container through the nozzle towards the support to form a second portion of the three-dimensional object adjacent to the first portion or the support, which second portion is formed upon solidification of the building material, wherein the second portion includes a second physical property that is different than the first physical property. In some embodiments, the at least one material container is a material cartridge. In an aspect, the present disclosure provides system for forming a three-dimensional object, comprising: a print head comprising a nozzle; at least one material container in fluid communication with said nozzle, wherein said at least one material container is configured to contain at least one building material; and a controller operatively coupled to said at least one material container, wherein said controller is programmed to: (i) direct said at least one building material in a liquid state from said at least one material container through said nozzle of said print head towards a support, and (ii) generate at least a portion of said three-dimensional object at variable fill density upon solidification of said at least one building material adjacent to said support.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates a schematic of a flow chart of a three-dimensional printing process;

FIG. 2 illustrates a front view of the cartridge system illustrating an exemplary mechanical system that transport building material from each syringe to a mixer;

FIG. 3 illustrates a top view of an exemplary bar that supports a syringe plunger in FIG. 2;

FIG. 4 illustrates a schematic picture of an exemplary printing process using the system of FIG. 1;

FIG. 5 illustrates an exemplary system with a 3D moving stage to form a 3D object;

FIG. 6 illustrates another embodiment of a 3D color printer;

FIG. 7 illustrates an exemplary 3D color printing process;

FIG. 8 illustrates an exemplary flow diagram of the process to build color objects;

FIG. 9 is a schematic illustration of a general process of 3D printing;

FIG. 10 provides a top cross-sectional view of a sphere of medium fill density;

FIG. 11 provides a top cross-sectional view of a sphere of high fill density;

FIG. 12 provides a top cross-sectional view of a sphere;

FIG. 13 provides a top cross-sectional view of a shoe sole with different fill densities in the front and heel;

FIG. 14 provides a side cross-sectional view of an object with three layers of different fill densities;

FIG. 15 provides a top cross-sectional view of a shoe sole with different materials in the front and heel;

FIG. 16 provides a side cross-sectional view of an object with three layers of different materials;

FIG. 17 is a photograph of an exemplary 3D printed object, wherein a subsection of area in a layer comprise honeycomb or hexagon shapes;

FIG. 18 is a photograph of another exemplary 3D printed object, wherein a subsection of area in a layer comprise square shapes;

FIG. 19 is a photograph of another exemplary 3D printed object that mimics human skin; and

FIG. 20 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “subsection,” as used herein, generally refers to an area of an object that is less than 100%, 95%, 90%, 80%, 70%, 75%, 60%, 50%, 40%, 30%, 20%, or 10% of a total area. For example, a subsection is 50% of the total area. The total area may have multiple subsections, such as at least 2, 3, 4, 5, 6, 7, 8, 9, 10, 20, 30, 40, 50, 100, or more subsections. Each subsection of the object may have a set of select material properties.

The term “layer,” as used herein, generally refers to a layer of atoms or molecules on a surface, such as a substrate. In some cases, a layer includes an epitaxial layer or a plurality of epitaxial layers (or sub-layers). A layer may generally have a thickness from about one monoatomic monolayer (ML) to tens of monolayers, hundreds of monolayers, thousands of monolayers, millions of monolayers, billions of monolayers, trillions of monolayers, or more. In an example, a layer is a multilayer structure having a thickness greater than one monoatomic monolayer. In addition, a layer may include multiple material layers.

The term “building material,” as used herein, generally refers to any material that may be used to generate at least a portion of a three-dimensional (3D) object. Building material may be in solid, semi-solid or liquid form. Building materials may be in liquid form that can be solidified by moisture, heat, ultraviolet (UV) light, or by other approaches. When in solid form, the solid may include particles. Building material may be in powder form. A building material powder may include individual particles with cross-sections (e.g., diameters) of at least about 5 nanometers (nm), 10 nm, 20 nm, 30 nm, 40 nm, 50 nm, 100 nm, 200 nm, 300 nm, 400 nm, 500 nm, 1 micrometer (μm), 5 μm, 10 μm, 15 μm, 20 μm, 35 μm, 30 μm, 40 μm, 45 μm, 50 μm, 55 μm, 60 μm, 65 μm, 70 μm, 75 μm, 80 μm, or 100 μm, or more. Such powder may be heated or melted to generate a liquid, which may be used to form the 3D object.

Building materials for forming 3D objects of the present disclosure may have different properties, such as viscosity, durability, color, conductivity and/or resistivity.

For example, a set of building materials with different colors may be used to form 3D objects of various colors.

The term “support,” as used herein, generally refers to any work piece on which a material used to form a 3D object, is placed. The 3D object may be formed directly on the base, directly from the base, or adjacent to the base. The 3D object may be formed above the base. The support may be a substrate. In some cases, the support may be removed subsequently, e.g. via dissolution in acids, bases or water. The other material (the build material) may form the three-dimensional object. The support may be disposed in an enclosure (e.g., a chamber). The enclosure can have one or more walls formed of various types of materials, such as elemental metal, metal alloy (e.g., stainless steel), ceramics, or an allotrope of elemental carbon. The enclosure can have shapes of various cross-sections, such as circular, triangular, square, rectangular, or partial shapes or combinations thereof. The enclosure may be thermally insulated. The enclosure may comprise thermal insulation. The enclosure may provide thermal or environmental insulation. The base can comprise an elemental metal, metal alloy, ceramic, allotrope of carbon, or polymer. The base can comprise stone, zeolite, clay or glass.

The term “about” when referring to a number or a numerical range means that the number or numerical range referred to is an approximation within experimental variability (or within statistical experimental error), and thus the number or numerical range may vary from, for example, between 1% and 15% of the stated number or numerical range.

The enclosure may be open to air or maintained in a controlled environment. In some examples, the enclosure is under an inert atmosphere, such as an inert gas (e.g., Ar, He, N₂, Kr, Xe, H₂, CO, CO₂, or Ne). The enclosure may be filled with a non-reactive gas.

As an alternative, the enclosure may be maintained under vacuum. The pressure in the chamber can be at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, 1000 bar, or more. The pressure in the enclosure may be at least 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, 1200 Torr. The pressure in the enclosure may be at most 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. In some cases the pressure in the enclosure may be standard atmospheric pressure.

Three-dimensional printing (3D printing) may refer to a process of forming a three-dimensional object. Such process may include additive manufacturing in which the 3D object is formed by adding material, or subtractive manufacturing in which the 3D object is formed by removing material. In an example, to form a three-dimensional object, multiple layers of a building material may be layered sequentially adjacent to one another.

In some cases, a three-dimensional object may have hollow parts, cavities, or areas that are not completely filled with building material. Hollow structures may be advantageous to reduce production and material cost. In some cases, it may be possible to create objects of distinct physical properties but may appear identical in appearance. This may be achieved by varying the fill density of the three-dimensional object. In contrast, building materials such as plastic, metal, or other hard or stiff materials may not allow a user to greatly vary the physical properties or macro properties of the resulting three-dimensional object.

A model design may be used to guide the formation of a 3D object or specific areas or subsections of building material that is directed onto the support to form the 3D object. The model design may be a computer-generated design, such as using 3D printing software. The layers of building material may be layered sequentially until the object formed takes the shape of the model design of the three-dimensional object.

### Materials

A three-dimensional object may be formed on a surface. The surface may be a flat surface, an uneven surface, a container, a build box, a box, a table, or any combination thereof.

In some cases, building materials used herein may include silicon, silicone rubber, siliconized acrylic caulk, an epoxy resin, polyurethane, fluoroelastomer, curable resin and alternatives. A building material may be a monomer, a dimer, or polymer. Additionally, building materials may include, but are not limited to, a fluid or paste that can be solidified by having the mixing chamber heated to a suitable temperature and delivered to the print head as melted thermo-plastically processable material. In this alternative embodiment the build material may comprise acrylonitrile-butadiene-styrene terpolymer (ABS), polycarbonate (PC), poly(meth)acrylate, polyphenylene sulfone (PPSU), HDPE, polyetherimide (PEI), polyether ether ketone (PEEK), polylactic acid (PLA) or a mixture of at least two of these polymers, or a mixture composed of at least 50% by weight of one of the polymers. The term (meth)acrylate here generally refers to either methacrylate, e.g. methyl methacrylate, ethyl methacrylate, etc. or acrylates, e.g. ethylhexyl acrylate, ethyl acrylate, etc., or else a mixture of the two. In relation to the second build material from the third nozzle, polymethacrylate or polycarbonate may be used in some cases. In relation to the support material from the first printing head, the system can use an acid-, base- or water-soluble polymer. A building material may be an acrylic paste, chocolate paste, jelly, ultraviolet (UV) light-curable resin, thermoplastic, or silicon solid or semi-solid (e.g., powder).

A building material may comprise a solid, a liquid, a gel, or any combination thereof.

A building material may comprise silicon, silicone rubber, siliconized acrylic caulk, polyurethane, fluoroelastomer, curable resin, or a fluid or paste that can be solidified. A building material may comprise a monomer, a dimer, or a polymer. The polymer may be an epoxy resin. In some cases, the solidification process may involve chemical reactions, radiation, cooling, dehydration, or drying. Materials that can dry spontaneously may also be used. A building material may be in a liquid state when in a material container or a material cartridge. A building material may solidify or undergo solidification when the building material is directed toward a support. The solidification of a building material on a support may form a portion of a three-dimensional object. The solidified building material may have a first physical property that is different than the building material when it is in a liquid state. The solidified building material may have a second physical property that is the same or similar to the building material when it is in a liquid state.

Materials in two or more colors may be used so that they can be mixed to form fluid in a desired color. A mixture used to print a three-dimensional object may comprise building materials from 1, 2, 3, 4, 5, 6, 7, 8, 9, 10 or more cartridges, and may comprise 1, 2, 3, 4, 5, 6, 7, 8, 9, 10 or more different colored building materials mixed together. Building materials may be colored with pigment soluble in the building material.

In some cases, a material cartridge comprises a first type of building material. In some cases, when the printer comprises at least two material cartridges, the two material cartridges comprise building materials that are of a first type of building material and a second type of building material. In some cases, when the printer comprises at least two material cartridges, the at least two material cartridges comprise building materials that are of the same type of building material. In some cases, when building materials from different cartridges are mixed to produce a mixture, the mixture is of a third type of building material that is different than the first type of building material and/or the second type of building material. In some cases, a three-dimensional object may be formed using only a single type of building material.

In some cases, a material cartridge comprises building material of a single color. In some cases, when the printer comprises at least two material cartridges, the two material cartridges comprise building materials that are of a first color and a second color. In some cases, when building materials from different cartridges are mixed to produce a mixture, the mixture is of a third color that is different than the first color and the second color.

When forming a three-dimensional object, smooth color transitions are possible. In some cases, a first mixture may be a drastically different or only slightly different color than a second mixture. Thus, smooth color transitions are possible to achieve a gradient of color in a three-dimensional object.

In some cases, a building material may comprise particles, oil, or water that can alter the characteristics of the resulting three-dimensional object. Physical characteristics of a three-dimensional object may be altered when using a method described herein. The characteristics that may be altered include rigidity, hardness, stiffness, flexibility, durability, density, tensile strength, elasticity, elongation-to-break, and other physical or chemical properties. In some cases, a first layer, a first subsection, or a first cross-section of a first layer of a three-dimensional object may have at least one physical property that is different when compared to a second layer, a second subsection, or a second cross-section of a second layer of the three-dimensional object, wherein the at least one physical property is rigidity, hardness, stiffness, flexibility, durability, density, tensile strength, elasticity, elongation-to-break, color, or a combination thereof.

In some cases, the building materials may also include additional additives, adhesion promoters, or adhesives. The building materials may be activated or may be heated by microwaves or by magnetic or electric fields. The additives may be premixed into a building material chamber, or may be in a separate chamber that is then mixed with various other building material chambers prior to extrusion by a print head. For example, one or more building materials can include crosslinking agents, initiators or accelerators that may come into contact another building material. During contact, a reaction may take place, such as a thermal reaction or other activation. In some cases, a reaction of building materials may produce a mixture that has different properties, such as the elasticity of the resulting mixture.

In some cases, a surface coating may also be added and a reaction can take place subsequently, wherein the additives may be activated by microwaves, heat, plasma, UV light or magnetic fields. In some cases, the reactions of an additives may occur on the surface, and may be beneficial and only desired on the surface of the three-dimensional object.

In an alternative embodiment, the additives from various syringes may themselves react with one another after the mixing process and thus give chemical crosslinking to catalyze solidification and/or improve the adhesion that the building materials downstream of the printing process exhibit towards one another. In another embodiment, downstream of the printing process one or more coating constituents can be deposited on the surface of the resulting object.

A building material may be a solid having fine particles. The building material can comprise individual particles, and the particles may be spherical, oval, cubic, irregularly shaped, or any combination thereof.

A building material may comprise particles of a substantially uniform size. A building material may comprise particles of at least about 0.1 micrometers, 0.2 micrometers, 0.3 micrometers, 0.4 micrometers, 0.5 micrometers, 0.6 micrometers, 0.7 micrometers, 0.8 micrometers, 0.9 micrometers, 1 micrometer, 2 micrometers, 5 micrometers, 10 micrometers, 20 micrometers, 30 micrometers, 40 micrometers, 50 micrometers, 60 micrometers, 70 micrometers, 80 micrometers, 90 micrometers, 100 micrometers, 200 micrometers, 300 micrometers, 400 micrometers, 500 micrometers, 600 micrometers, 700 micrometers, 800 micrometers, 900 micrometers, or 1 millimeter. In some cases, a building material may comprise particles of 10 micrometers to 100 micrometers, 20 micrometers to 90 micrometers, 30 micrometers to 80 micrometers, or 40 micrometers to 60 micrometers. In some cases, a building material may comprise particles of about 50 micrometers.

The method of forming a three-dimensional object may require deposition of multiple layers to building material. The method of forming a three-dimensional object may require at least 1 layer, 2 layers, 3 layers, 4 layers, 5 layers, 6 layers, 7 layers, 8 layers, 9 layers, 10 layers, 50 layers, 100 layers, 200 layers, 500 layers, 700 layers, 1000 layers, or more layers of building material to form the object. The object may require 1 to 1000 layers of building material, 10 to 700 layers, 100 to 500 layers, or 200 to 400 layers to complete the formation of the object. The object may require 10 to 1000 layers of building material, 100 to 700 layers, 200 to 600 layers, or 300 to 500 layers to complete the formation of the object.

A layer of building material may be distributed uniformly on a surface. A layer of building material may have a certain thickness on at least a portion of a surface or support. A layer of building material may have a thickness of at least about 0.001 millimeters, 0.01 millimeters, 0.1 millimeters, 0.2 millimeters, 0.3 millimeters, 0.4 millimeters, 0.5 millimeters, 0.6 millimeters, 0.7 millimeters, 0.8 millimeters, 0.9 millimeters, 1 millimeter, 2 millimeters, 5 millimeters, 10 millimeters, 20 millimeters, 30 millimeters, 40 millimeters, 50 millimeters, 60 millimeters, 70 millimeters, 80 millimeters, 90 millimeters, or 100 millimeters. A layer of building material may have a thickness of 0.1 millimeters to 10 millimeters, 0.3 millimeters to 5 millimeters, 0.4 millimeters to 2 millimeters, 0.5 millimeters to 1 millimeter. In some cases, a three-dimensional object may comprise more than one layer, wherein the thickness of each of the layers may be the same, about the same, or different.

A three-dimensional object may mimic skin or tissue, and may have a thickness of at least about 0.001 millimeters, 0.01 millimeters, 0.1 millimeters, 0.2 millimeters, 0.3 millimeters, 0.4 millimeters, 0.5 millimeters, 0.6 millimeters, 0.7 millimeters, 0.8 millimeters, 0.9 millimeters, 1 millimeter, 2 millimeters, 5 millimeters, 10 millimeters, 20 millimeters, 30 millimeters, 40 millimeters, 50 millimeters, 60 millimeters, 70 millimeters, 80 millimeters, 90 millimeters, or 100 millimeters.

The building material may have a viscosity of less than or equal to about 100,000,000 centipoise (cP), 10,000,000 cP, 1,000,000 cP, 100,000 cP, 10,000 cP, 1000 cP, 900 cP, 800 cP, 700 cP, 600 cP, 500 cP, 400 cP, 300 cP, 200 cP, 100 cP, 50 cP, 10 cP, 9 cP, 8 cP, 7 cP, 6 cP, 5 cP, 4 cP, 3 cP, 2 cP, 1 cP, or less. The binding substance may have a viscosity of 1000 cP to 100 cP, 700 cP, to 200 cP, or 600 cP to 300 cP.

The building material may be stored in a container, a bottle, a cup, or a vessel.

In some cases, a mixer is a channel, a chamber, a tube, or a connector. In some cases, building material from different containers may be mixed by a mechanical mixer, and may comprise a blade, a whisk, or a combination thereof.

In some cases, the print head takes in building material and extrudes it to print the three-dimensional object, and the dimension of the print head tip can define the resolution of printed objects. In some cases, a print head may be a needle, a nozzle, or a ball-pen head. The print head can be replaceable or changeable according to materials choice, resolution requirement, or clogging prevention. In some embodiments, the print head module can have a capability of mixing building materials. For example, a static mixing nozzle can be utilized as a print head module which can mix incoming building materials and extrude it. A static mixing nozzle can mix the solution at an affordable cost, and the inner diameter of the nozzle tip can be optimized between a large nozzle (which may decrease the probability of clogging) and a small nozzle (which may increase the precision of the printing).

A three-dimensional object may have a height, a width, and a length, which may be the same or different. A three-dimensional object may have a height, a width, or a length that is, individually and independently, greater than about 0.1 millimeters, 0.5 millimeters, 1 millimeter, 2 millimeters, 5 millimeters, 10 millimeters, 20 millimeters, 30 millimeters, 40 millimeters, 50 millimeters, 60 millimeters, 70 millimeters, 80 millimeters, 90 millimeters, 100 millimeters, 200 millimeters, 300 millimeters, 400 millimeters, 500 millimeters, 600 millimeters, 700 millimeters, 800 millimeters, 900 millimeters, 1 meter, or more. A three-dimensional object may have a height greater than about 20 millimeters, 50 millimeters, 100 millimeters, 200 millimeters, 300 millimeters, 400 millimeters, 500 millimeters, 600 millimeters, 700 millimeters, 800 millimeters, 900 millimeters, 1 meter, 2 meters, 3 meters, 5 meters, 10 meters, or more. A three-dimensional object may have a width greater than about 20 millimeters, 50 millimeters, 100 millimeters, 200 millimeters, 300 millimeters, 400 millimeters, 500 millimeters, 600 millimeters, 700 millimeters, 800 millimeters, 900 millimeters, 1 meter, 2 meters, 3 meters, 5 meters, or 10 meters. A three-dimensional object may have a length greater than about 20 millimeters, 50 millimeters, 100 millimeters, 200 millimeters, 300 millimeters, 400 millimeters, 500 millimeters, 600 millimeters, 700 millimeters, 800 millimeters, 900 millimeters, 1 meter, 2 meters, 3 meters, 5 meters, or 10 meters. In some cases, a three-dimensional object may have dimensions of about 1 m by 1 m by 1 m. In some cases, a three-dimensional object may have dimensions of about 500 millimeters by 500 millimeters by 500 millimeters. In some cases, a three-dimensional object may have dimensions of about 200 millimeters by 200 millimeters by 200 millimeters.

### Methods

In an aspect, the current disclosure provides a method for forming a three-dimensional object. The method may comprise providing at least two material cartridges that are in fluid communication with a mixer that is in fluid communication with a nozzle of a print head. The at least two material cartridges may contain building materials. Next, building materials from the at least two material cartridges may be used to generate a first mixture in the mixer. The first mixture may be directed from the mixer through the nozzle towards a support to form a first layer of the three-dimensional object adjacent to the support. The first layer may comprise a first perimeter and a first subsection of area within the first perimeter. Next, building materials from the at least two material cartridges may be used to generate a second mixture in the mixer. The second mixture may then be directed from the mixer through the nozzle towards the support to form a second layer of the three-dimensional object adjacent to the support. The second layer may comprise a second perimeter and a second subsection of area within the second perimeter, wherein at least a portion of the second subsection is adjacent to at least a portion of the first subsection.

Such operations may be repeated at least 2, 3, 4, 5, 6, 7, 8, 9, 10, 20, 30, 40, 50, 100, 200, 300, 400, 500, 1000 or more times.

In another aspect, the present disclosure provides a system for forming a three-dimensional object. The method may comprise a print head comprising a nozzle that may be in fluid communication with a mixer in fluid communication. The at least two material cartridges may be in fluid communication with the mixer. The at least two material cartridges may be configured to contain building materials. A controller may be operatively coupled to the at least two material cartridges. The controller may be programmed to use the building materials from the at least two material cartridges to generate a first mixture in the mixer. The controller may be programmed to direct the first mixture from the mixer through the nozzle towards a support to form a first layer of the three-dimensional object adjacent to the support. The first layer may comprise a first perimeter and a first subsection of area within the first perimeter. The controller may be programmed to use the building materials from the at least two material cartridges to generate a second mixture in the mixer. The controller may be programmed to direct the second mixture from the mixer through the nozzle towards the support to form a second layer of the three-dimensional object adjacent to the support. The second layer may comprise a second perimeter and a second subsection of area within the second perimeter. At least a portion of the second subsection may be adjacent to at least a portion of the first subsection.

An apparatus may be used to create three-dimensional objects include a printhead and an extrusion module. The extrusion module may be able to transfer building material from one or more cartridges to the printhead. The cartridge can be a tank, bottle, syringe, or any container that can hold viscous material. The force used to transport building material from the cartridge to the printhead can be mechanical force, pneumatic force, gravity force, osmotic pressure difference, surface tension, magnetic force, or forces caused by pressure difference. The printhead may determine the resolution of the printed objects, and it can be made of plastic, metal, or other materials.

In some cases, the nozzle is configured to move over the support without directing building material towards the support when moving over the first subsection within the first perimeter. Such movement may be relative movement. In some examples, the nozzle is moved but the support is stationary. As an alternative, the nozzle is stationary but the support is moved (e.g., along an XY plane). As another alternative, both the nozzle and the support are moved.

A subsection may be less than about 99%, 95%, 90%, 80%, 75%, 70%, 60%, 50%, 40%, 30%, 20%, or 10% of an area enclosed by a first perimeter. In some cases, a cross-section of an object is not 100% filled, and may be less than 100%, 99%, 95%, 90%, 80%, 75%, 70%, 60%, 50%, 40%, 30%, 20%, or 10% filled.

In some cases, a method further comprising filling a cavity of a three-dimensional object, wherein the cavity makes up at most 99%, 95%, 90%, 80%, 75%, 70%, 60%, 50%, 40%, 30%, 20%, or 10% of the volume of the three-dimensional object. The cavity of the three-dimensional object may be filled at an average rate of at least about 0.01 cubic millimeters per second (mm³/s), 0.1 mm³/s, 0.2 mm³/s, 0.3 mm³/s, 0.4 mm³/s, 0.5 mm³/s, 0.6 mm³/s, 0.7 mm³/s, 0.8 mm³/s, 0.9 mm³/s, 1 mm³/s, 2 mm³/s, 3 mm³/s, 4 mm³/s, 5 mm³/s, 6 mm³/s, 7 mm³/s, 8 mm³/s, 9 mm³/s, 10 mm³/s, 100 mm³/s, 500 mm³/s, 1000 mm³/s, 2000 mm³/s, 3000 mm³/s, 4000 mm³/s, 5000 mm³/s, 6000 mm³/s, 7000 mm³/s, 8000 mm³/s, 9000 mm³/s, 10,000 mm³/s, or greater.

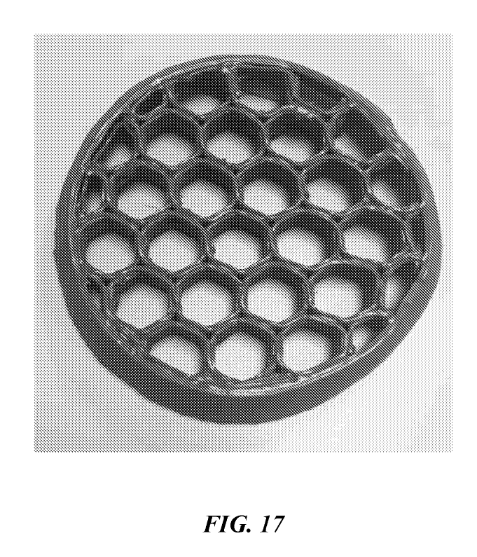

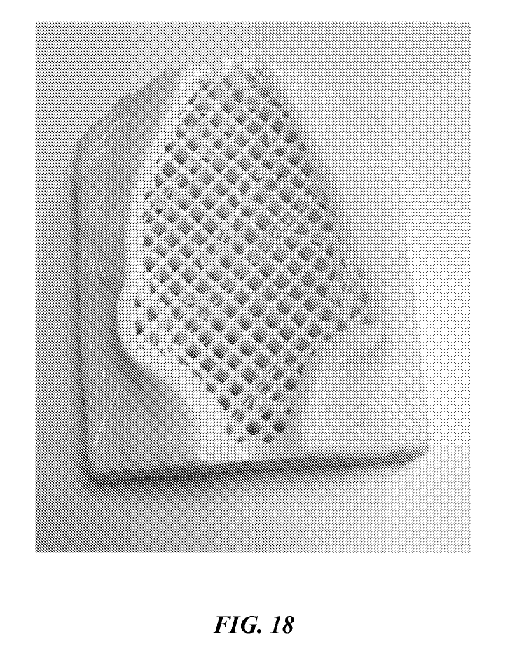

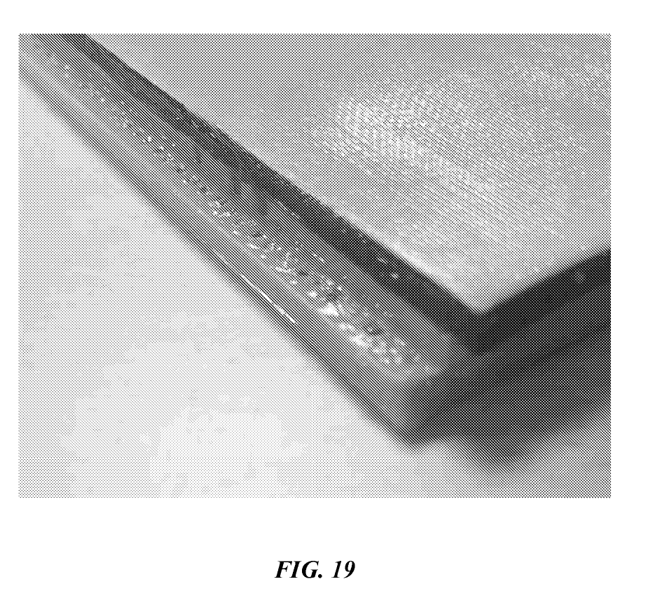

A subsection may have a pattern, and the pattern may have a honeycomb shape, a diamond shape, a square shape, a round shape, or a combination thereof. FIG. 17 is a photograph of an exemplary 3D printed object, wherein a subsection of area in a layer comprises honeycomb or hexagon shapes. FIG. 18 is a photograph of another exemplary 3D printed object, wherein a subsection of area in a layer comprises square shapes.

A cross-section of a three-dimensional object may be referred to as having different fill densities. A cross-section may have sections with the same fill density, different fill density, or gradients of fill density. A three-dimensional object formed may have at least a portion with variable fill density after solidification of the building material. In some cases, a fill density of a layer or cross-section of a three-dimensional object may be at least about 1%, 2%, 3%, 4%, 5%, 10%, 20%, 30%, 40%, 50%, 60%, 70%, 80%, 90%, or 95%.

A first cross-section of a three-dimensional object may have the same or substantially similar physical properties than a second cross-section of the same three-dimensional object. Alternative, the first cross-section of the three-dimensional object may have different physical properties than the second cross-section of the same three-dimensional object.

A first layer of a three-dimensional object may have the same or substantially similar physical properties than a second layer of the same three-dimensional object. Alternative, the first layer of the three-dimensional object may have different physical properties than the second layer of the same three-dimensional object.

In some cases, a hardness of a three-dimensional (3D) object may be measured according to the Shore A Hardness Scale. The 3D object may have a hardness of at least about 1A, 2A, 3A, 4A, 5A, 6A, 7A, 8A, 9A, 10A, 15A, 20A, 25A, 30A, 40A, 50A, 60A, 70A, 80A, 90A, 100A, 150A, 200A, or more. In some cases, the 3D object may have a hardness of at most about 200A, 150A, 100A, 90A, 80A, 70A, 60A, 50A, or less. The hardness may be from 1A to 100A, or 5A to 80A.

In some examples, fill density of a layer or a cross-section of a three-dimensional object may impart different physical properties of the three-dimensional object. A hardness of a three-dimensional object may be related to a fill density of the object. For example, a higher fill density may impart a greater hardness than a lower fill density.

In some example, two building material cartridges have different physical properties or parameters. Two building material cartridges may have building materials that are of a different color or different material composition.

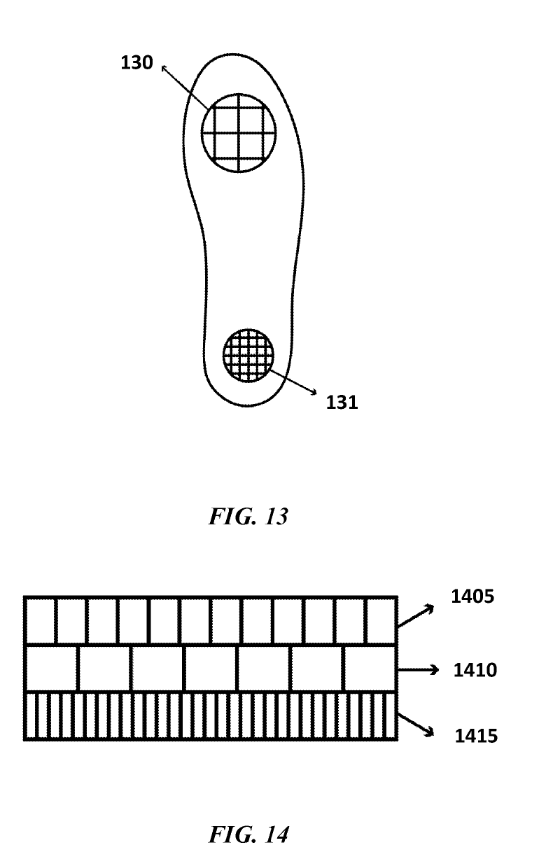

FIG. 13 provides a top cross-sectional view of a shoe sole with different fill densities in the front 1305 and heel 1301. FIG. 14 provides a side cross-sectional view of an object with three layers of different fill densities 1405, 1410, and 1415.

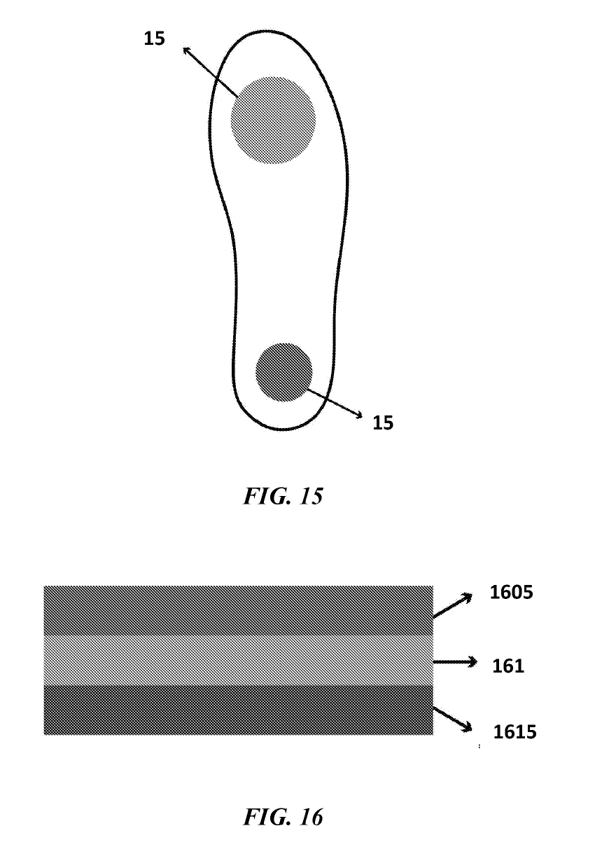

In some cases, an object may comprise of different building materials. FIG. 15 provides a top cross-sectional view of a shoe sole with different materials in the front 1505 and heel 1501. FIG. 16 provides a side cross-sectional view of an object with three layers of different materials 1605, 1610, and 1615.

The disclosure also includes a method to alter the physical properties by using more than one material within one object. For example, a shoe sole can consist of three materials to provide distinct mechanical properties in different parts of the shoe sole. Alternatively, in some cases, an object can have multiple layers of different materials. The disclosure allows multi-material objects to be created in one process, possibly with different structures.

A three-dimensional object described herein may be formed using a printer. A printer may include one or more cartridges with a building material stored therein. A mixture of building materials from the one or more cartridges may be formed in a mixer. The mixture may be directed to the nozzle or the print head for extrusion of the material. The mixture may be extruded towards the support. The nozzle or print head may continuously extrude building material or may pass over sections of the support without extruding building material.

A layer of building material may be deposited onto the support via a print head or a nozzle of a print head. The distance between a component of the print head and the layer of building material on the surface may be at least 1 centimeter (cm), 5 cm, 10 cm, 20 cm, 30 cm, 40 cm, 50 cm, 60 cm, 70 cm, 80 cm, 90 cm, 1 m, or more. The distance between a component of the print head and a layer of building material may change over the course of formation of the three-dimensional object. In some cases, the distance between a component of the print head and a layer of building material may decrease over the course of formation of the three-dimensional object.

The building material may be stored in a reservoir or vessel of building material. The reservoir may hold at least about 10 grams (gr), 100 gr, 200 gr, 500 gr, 750 gr, 1 kilogram (kg), 2 kg, 5 kg, 10 kg, or more of building material.

The print head may dispense building material at an average rate of at least about 0.01 cubic millimeters per second (mm³/s), 0.1 mm³/s, 0.2 mm³/s, 0.3 mm³/s, 0.4 mm³/s, 0.5 mm³/s, 0.6 mm³/s, 0.7 mm³/s, 0.8 mm³/s, 0.9 mm³/s, 1 mm³/s, 2 mm³/s, 3 mm³/s, 4 mm³/s, 5 mm³/s, 6 mm³/s, 7 mm³/s, 8 mm³/s, 9 mm³/s, 10 mm³/s, 100 mm³/s, 500 mm³/s, 1000 mm³/s, 2000 mm³/s, 3000 mm³/s, 4000 mm³/s, 5000 mm³/s, 6000 mm³/s, 7000 mm³/s, 8000 mm³/s, 9000 mm³/s, 10,000 mm³/s, or greater. The print head may dispense building material at an average rate of at most about 100 mm³/s, 90 mm³/s, 80 mm³/s, 70 mm³/s, 60 mm³/s, 50 mm³/s, 40 mm³/s, 30 mm³/s, 20 mm³/s, 10 mm³/s, 9 mm³/s, 8 mm³/s, 7 mm³/s, 6 mm³/s, 5 mm³/s, 4 mm³/s, 3 mm³/s, 2 mm³/s, 1 mm³/s, or less. The print head may dispense the building material at an average rate from about 0.01 mm³/s to 100 mm³/s, or 0.1 mm³/s to 10 mm³/s. A printer may regulate the rate at which a print head dispenses building material or the rate at which building material is directed towards a support. The rate may regulate the fill density of at least a portion of the three-dimensional object.

A building material may be applied to a layer of building material at a certain flow rate from a container, print head, nozzle, or pump. In some cases, a building material may be applied at a flow rate of less than or about 100 mL/s, 90 mL/s, 80 mL/s, 70 mL/s, 60 mL/s, 50 mL/s, 40 mL/s, 30 mL/s, 20 mL/s, 10 mL/s, 9 mL/s, 8 mL/s, 7 mL/s, 6 mL/s, 5 mL/s, 4 mL/s, 3 mL/s, 2 mL/s, or 1 mL/s.

In some cases, building materials are directed to a nozzle by a force. The force may be mechanical force, pneumatic force, gravity, osmotic pressure difference, pressure difference, or a combination thereof. A building material may be directed to the nozzle using positive pressure or negative pressure. Positive pressure may be provided using a compressor. Negative pressure may be provided using a pump.

In some cases, a nozzle moves to a subsection of area relative to a support. In some cases, a nozzle may move over a certain area of the support without directing building material towards the support, thus forming an open area of a layer of the three-dimensional object.

In some cases, three-dimensional objects created with the methods described herein can have different properties even when the material is identical. One method to control physical properties of printed three-dimensional objects may be to vary the internal structure of the printed objects. Conventional FDM 3D printer can create objects of various internal structures, but the physical properties of the produced thermoplastic objects barely change. The current method may use viscous material as the building material, and the printed three-dimensional objects may be flexible. The density, Young's module, tensile strength, hardness, toughness, or gas permeability of a printed object can vary according to its internal structure. For example, the fill density of a 3D printed silicone object can affect its hardness and Young's module. When the fill density is higher, the hardness and Young's module are higher. Objects of higher file density require more building material, and may take longer to build.

The internal structure can also make the printed object anisotropic by creating anisotropic internal structure even if the object looks isotropic externally. For example, an object of cubic internal structure has similar mechanical properties in X and Y directions. An object with only vertical line inner structure (walls along the Y direction) may have anisotropic mechanical properties in X and Y directions. Building on this example, the method described herein can create three-dimensional objects of anisotropic physical properties by adjusting the internal structure. The disclosure also allows physical properties to vary across a printed object. It's feasible that an object contains some hard regions and some soft regions. For instance, a 3D printed shoe sole can have a soft vamp and a hard build-up portion by constructing the shoe sole with multiple densities in a piece, allowing the product to fit different applications. Similarly, an object can have distinct structures along the vertical axis, which is a common structure of a shoe sole.

Certain areas of a layer of the three-dimensional object may not comprise building material. The design of the three-dimensional object may influence the physical properties of the three-dimensional object, such as, for example, hardness, flexibility, durability, texture, and density. A three-dimensional object may be anisotropic. Such anisotropic three-dimensional object may have one or more physical properties that are different when measured in different directions. A three-dimensional object may be isotropic. Such isotropic three-dimensional object may have one or more physical properties that are the same when measured in different directions.

A building material may be applied a perimeter of a layer of the three-dimensional object. A building material may be applied an area within the perimeter. The building material may be applied to an area of greater than about 1%, 5%, 10%, 20%, 30%, 40%, 50%, 60%, 70%, 80%, 90% or 99% of the layer. In some cases, the building material may be applied to an area of less than about 99%, 90%, 80%, 70%, 60%, 50%, 40%, 30%, 20%, or 10% of the layer. In some cases, a building is applied to 5% to 90%, 10% to 80%, 30% to 70%, 40% to 60%, or 40% to 60% of the layer.

The distance between a print head or nozzle head and the layer of building material on the surface may stay constant throughout the application of a single layer of building material. The distance between a print head or nozzle head and the layer of building material on the surface may differ from one application of a layer to another application of a layer of building material. In some cases, the distance between the print head or nozzle head and the layer of building material decreases as the number of layers of the three-dimensional object increases. The distance between a print head or nozzle head and the layer of building material on the surface may be at least 0.1 millimeters (mm), 0.5 mm, 1 mm, 2 mm, 5 mm, 10 mm, 50 mm, 100 mm, 200 mm, 300 mm, 400 mm, 500 mm, 600 mm, 700 mm, 800 mm, 900 mm, 1000 mm, or more.

A layer of the three-dimensional object may be formed or partially formed inside a confined space, or in a container. The confined space may comprise hydrogen, nitrogen, argon, oxygen, carbon dioxide, or any combination thereof. In some cases, the level of oxygen in the confined space may less than 100,000 parts per million (ppm), 10,000 ppm, 1000 ppm, 500 ppm, 400 ppm, 200 ppm, 100 ppm, 50 ppm, 10 ppm, 5 ppm, or 1 ppm. The confined space may comprise water vapor. The amount of water in the confined space may be less than 100,000 parts per million, 10,000 ppm, 1000 ppm, 500 ppm, 400 ppm, 200 ppm, 100 ppm, 50 ppm, 10 ppm, 5 ppm, or 1 ppm. The three-dimensional object may be formed or partially formed while exposed to the atmosphere. The atmosphere may comprise hydrogen, nitrogen, argon, oxygen, carbon dioxide, or any combination thereof. A layer of the three-dimensional object may be formed under an open atmosphere and not in a container. The open atmosphere may be within a room or a building wherein the air inside the room or building is open to atmospheric air.

A three-dimensional object may be formed in a period of at least about 1 minute, 2 minutes, 3 minutes, 4 minutes, 5 minutes, 6 minutes, 7 minutes, 8 minutes, 9 minutes, 10 minutes 30 minutes, 1 hour, 2 hours, 3 hours, 4 hours, 5 hours, 10 hours, 20 hours, 30 hours, 40 hours, 50 hours, 75 hours, 4 days, 5 days, 1 week, 2 weeks, 3 weeks, or 4 weeks. A three-dimensional object may be formed in a period of 1 minute to 50 hours, 30 minutes to 30 hours, 1 hour to 20 hours, 2 hours to 10 hours, or 3 hours to 10 hours.

A computer system or controller may be used in a method of the current disclosure to design a model of a three-dimensional object. A computer system may be pre-programmed with information before the formation of the object. A model design may be generated prior to the beginning of formation of the three-dimensional object, or the model design may be generated in real time (i.e. during the process of formation of the three-dimensional object). The model design may be generated on a computer.

In some cases, the three-dimensional object formed may have a deviation from the dimensions of the model design. The deviation of the three-dimensional object formed and the model design may be at most 1 cm, 9 mm, 8 mm, 7 mm, 6 mm, 5 mm, 4 mm, 3 mm, 2 mm, 1 mm, 90 micrometers, 80 micrometers, 70 micrometers, 60 micrometers, 50 micrometers, 40 micrometers, 30 micrometers, 20 micrometers, 10 micrometers, 5 micrometers, or less.

Deviation may be present between the three-dimensional object formed and the model design. An individual part of the three-dimensional object may deviate from a corresponding part of the model design by at least about 0.1%, 1%, 2%, 3%, 4%, 5%, 10%, 20%, 30%, 40%, 50%, 60%, 70%, 80%, 90% or 99%.

The model design may include at least about 1, 2, 3, 4, 5, 6, 7, 8, 9, 10, 100, 1000, 10,000, 50,000, or 100,000 cross-sections. The model design may comprise 1 to 1000 cross-sections (or slices), 10 to 700 cross-sections, 100 to 500 cross-sections, or 200 to 400 cross-sections of the object. The model design may comprise 10 to 1000 cross-sections, 100 to 700 cross-sections, 200 to 600 cross-sections, or 300 to 500 cross-sections of the three-dimensional object. Such cross-sections (or slices) may be generated by 3D printing software, and may be in accordance to a model design of the three-dimensional object.

The speed at which a stream of building material is extruded from the print head may be at least about 1 mm/second (s), 10 mm/s, 100 mm/s, 200 mm/s, 300 mm/s, 400 mm/s, 500 mm/s, 600 mm/s, 700 mm/s, 800 mm/s, 900 mm/s, 1000 mm/s, 1250 mm/s, 1500 mm/s, 1750 mm/s, 2000 mm/s, or more. The speed at which a stream of building material is extruded from the print head may be at least about 1 mm/min, 10 mm/min, 100 mm/min, 200 mm/min, 300 mm/min, 400 mm/min, 500 mm/min, 600 mm/min, 700 mm/min, 800 mm/min, 900 mm/min, 1000 mm/min, 1250 mm/min, 1500 mm/min, 1750 mm/min, 2000 mm/min, or more.

In some cases, the methods described herein may be fully automated process. The design of the three-dimensional object may be generated from a computer program or software. Such design may be generated upon request by a user. The generation of a mixture may be automated by a computer system. The directing of the mixture to a support may be automated or controlled by a computer system. In some cases, a step of a method described herein may not be fully automated processes and may require a worker.

In some cases, a process described herein involves a print head, building material, and a printing surface. Building material may flow from the printhead and stick to the printing surface after the printhead moves to another position. In order to create a three-dimensional object of hollow internal structure, the print head may move to only to a sub-region of the printing surface. Alternatively, a print head may stop flowing building material in a sub-region of the surface. In some cases, only a part of the printing surface is deposited with building material. By tuning the parameter in the control system (PC, mobile device, tablets, or other device that can take inputs), the degree of fill density can be controlled, thus giving various physical properties of the printed three-dimensional object.

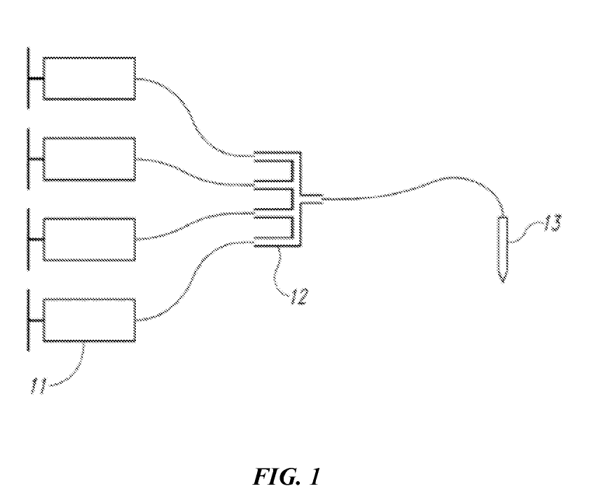

FIG. 1 shows an exemplary color 3D printing system that includes a plurality of building material cartridges 11, a mixer 12, and a print head 13 with a single heat extruder. Building materials stored in the cartridge 11 may be transported to the print head 13, mixed along the pathway, and deposited from the tip when they are in a liquid or semi-liquid state. The building materials may be extruded from the tip. The building materials may flow out of the tip in liquid form (e.g., droplets) towards a support. The droplets may subsequently be solidified adjacent to the support, such as upon cooling.

Each cartridge 11 may store building materials before they are transported. More than one cartridge may be used to store fluids in various properties or parameters, such as, for example, color, hardness, and density. The building materials may be stored as syringes to make the transportation of building material easy. Alternative storing devices can be tubes, bottles, or other liquid containers as long as the liquid inside can be transported out as requested.

A system may comprise at least 1, 2, 3, 4, 5, 6, 7, 8, 9, 10, 20, 30, 40, or 50 cartridges. In cases in which multiple cartridges are used, the cartridges may have different building materials, such as building materials of different colors or other properties (e.g., hardness or viscosity). In some examples, the system has four cartridges. Each cartridge may have building materials of a color from red (or magenta), yellow, blue (or cyan), and white (or clear). Material in black (key) can be used to replace white/clear material so the system is similar to CMYK color system. However, three-cartridge system or a system with different number of cartridges may be used.

The system may use a single extruder to provide energy for the melting. The single extruder may deposit the mixed droplets to form a continuous full color object. In contrast, the conventional system with multiple extruders may not provide continuous full color as each droplet may be too large (much larger than the size of ink droplets in a desktop inkjet printers and the melted plastic cools down as soon as it touches the support and gets solidified. The single extruder approach can also handle melted thermoplastics, the common building material of different colors since they melt at above 200 degree Celsius.

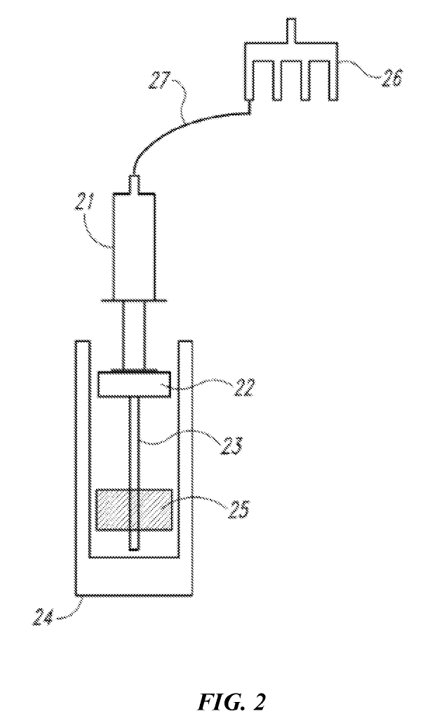

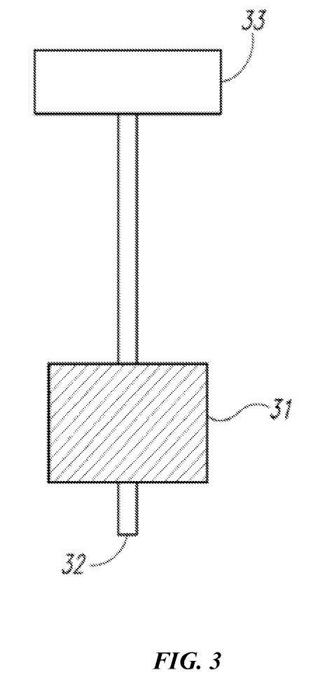

FIG. 2 illustrates building material in a syringe 21 that is ejected by a plunger of the corresponding syringe during extrusion. A bottom portion of the syringe 21 may contact a bar-shape component 22 connected to a threaded rod 23. As detailed in FIG. 3, a pusher 33 is fixed to a threaded rod 32 and the rod is driven by a stepper motor 31. In FIG. 2, the bar 22 and the plunger move along the guide 24 as the threaded rod is rotated by the stepper motor 25, which is capable of rotating by a small angle so the plunger moves incrementally, resulting in small volume of building material transported. Syringe 21 moves building material through a line 27 to mixer 26.

In some cases, four cartridges are connected with tubes to the mixer in order for building materials in different colors to mix as they flow to the print head module. The mixer can be a five-way connector (or a connector with a different number of open-ends). Alternatively, a static mixer (like an inline mixer) or an active mixer can serve as the core component of the mixer. The material of the connector can be plastic, metal or other material as long as it is liquid sealed. The color flowing out from one-end of the connector is determined by the relative flow rates of the incoming materials, which are in two (or more) colors. The flow rate from the one-end of the connector may be a constant defined by users, no matter of which color the mixed material is flowing out. That is, the flow rates of incoming materials in various colors may be summed up to a user-defined constant, and the ratios between them give the color of outflowing material. The distance between the mixer and the print head module may be a controllable factor when forming a three-dimensional object. When the path between the mixer and the print head module is short, the intervals between color transitions may be shorter as materials have less time to mix along the shorter pathway. On the other hand, the color transition intervals may be larger with a better mixing quality if the path between the mixer and print head module is larger. The tubes used to connect modules may be sufficiently thin to minimize the delay between color transitions, and they should be long enough so that the motion of the nozzle is not confined. This mixer can be designed to be disposable in order to maintain the quality of printing.

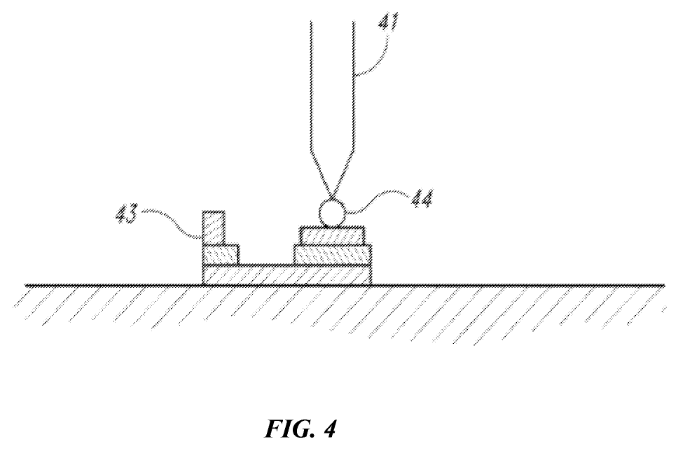

As shown in FIG. 4, the printing process may involve the print head of the nozzle 41, a support, and building material coming from the nozzle 13. The building material, which is paste-like in one embodiment, comes from the nozzle droplet by droplet 44, and it starts to solidify. The solidification rate may be controlled so that a droplet is substantially solidified when making contact with the support or the object below 43 but the material coming right out from the print head remains liquid so the head may not be obstructed by materials.

The system can stand alone or be integrated with other system. For example, a hand-held color 3D printer embodiment allows users to print 3D objects in various colors on a surface, in the air, or in solution. Alternatively, the system can be mounted on an existing 3D printer to convert the conventional printer into a multi-color 3D printer.

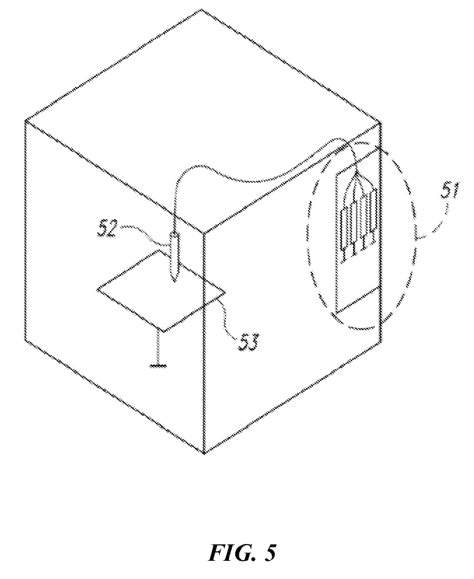

In another embodiment shown in FIG. 5, the cartridge module and mixer 51 are fixed with respect to the framework of a 3D printer, while the print head module 52 is moveable. A support 53 is used to support the printed 3D object.

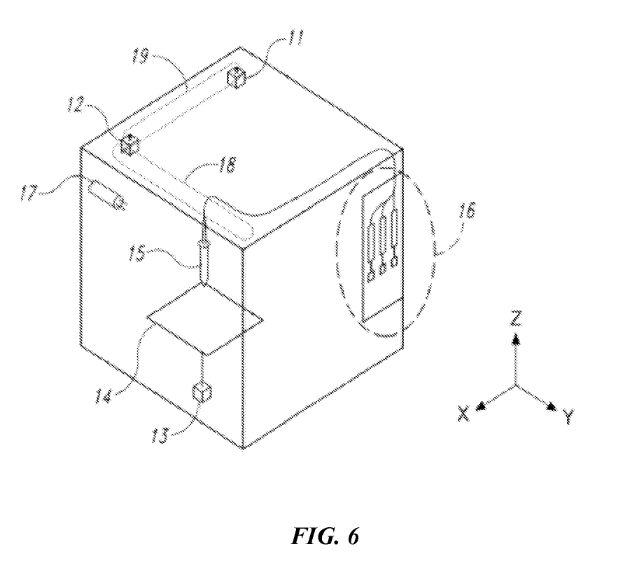

FIG. 6 shows another embodiment of a 3D color printer. In FIG. 6, the color 3D printer consists of a mechanical system that precisely defines the relative positions of the extruding nozzle 15 and the support 14, a light system that used to cure polymers 17, and a extrusion system that prints objects moving along axis 18 and 19. Curable building materials stored in the cartridges 16 are transported to the nozzle, mixed well along the pathway, and extruded from the tip. The extruded droplet of liquid building material is solidified on the support as shined by the radiation. As the nozzle is moving, the droplet can be printed to any place on the support, so the structure of printed material can be determined. The mechanical system may control the positions of the nozzle and the support, in some cases with at least 1, 2, 3, 4, or 5 motors. The support may be a support to solidified objects. It can be made of metal or plastics and some coatings may be applied to the surface to create an optimal binding force between the support and the printed objects. The nozzle is fixed to the y-axis belt controlled by a y-axis motor in the way that the nozzle is moving along the y-axis as the y-axis motor spins. The y-axis belt may be supported by rods along the y-axis in order to increase its robustness. The y-axis belt is then fixed to a wheel on the x-axis belt so the whole y-axis belt can move along the x-axis according to the x-axis motor. The belt system controlled by the two motors decides the x and y positions of the nozzle while the height of it remains a constant. The z-position of the support is maneuvered by the z-axis motor, which may be done in the way that the motor is connected concentrically to a threaded rod, coupled to the support so that the support moves along the threaded rod (the z-axis) as the motor spins. The motors used in the mechanical system may be stepper motors. Such stepper motors may have a small increment when they spin, so the position of the nozzle can be precisely defined. The power of movements is provided and translated by motors and belts in the example, but gear systems or robotic arms may be included as an alternative. A calibration device may be used to precisely determine the positions of the components, and it can include but not limited to the following, collision sensors, I sensors, or labeled tracks. Taking the collision sensors as an example, the nozzle will move towards the boundary of the X- and Y-axes until it hits the sensor. This point is defined as the origin, and the coordinate of the nozzle can be tracked by recording the angle rotated for the stepper motors.

The building material utilized in the embodiment of FIG. 6 can be light-curable resins, and alternatives include but not limit to fluids that can be solidified as radiated, cooled, or dried. Materials in three or more colors are used so that they can be mixed to form homogeneous fluid in a desired color, and they are colored with pigment that can be dissolved in the building material before being filled in the cartridges. As the common light curable material is a polymer, these pigments may be oil-dissolved. The light system includes a radiation source to solidify the building material extruded from the nozzle and the solidified droplet can be attached to the support or the object below that has been built. A radiation source is utilized to solidify light-curable resin, and possible options include, but are not limited to, UV, visible light, and laser. The geometric relationship between the light source and a printed object can vary. The light focuses on the spot of the printed droplet, or shines on the whole support from the top, or shines from the bottom to allow fluid be solidified on the support. The radiation source may be controlled to switch on and off or move during the process of printing.

The extrusion system of FIG. 6 includes a mixing nozzle and a cartridge system. The nozzle is fixed to a wheel on the y-axis belt so it is able to move within the X-Y plane. A tube is connected to the nozzle in order to allow building material to flow into the nozzle, well mixed and extruded. A static mixing nozzle may be used to mix the solution at an affordable cost, and the inner diameter of the nozzle should be optimized between a large one (which decreases the probability of clogging) and a small one (which increases the precision of the printing). The tube used is sufficiently thin to minimize the delay between color transitions, and they should be long enough so that the motion of the nozzle is not confined.

Next, the cartridge system is detailed. Several cartridges to store fluids in different colors may be included. Such cartridges can be syringes, bottles, or other liquid containers as long as the liquid inside can be transported out as requested. In some cases, a four-cartridge system may be used: each cartridge may have the building materials of a color from red, yellow, blue, and white (clear). In this example, syringes may be used to make the transportation of building material easy. The syringe should be covered with light blocks, such as dark sheets or a lightproof box to prevent building materials from the exposure of radiation, which causes solidification. Three cartridges are connected with soft tubes to a many-to-one adaptor (such as 3 to 1 adapter) in order for building materials in different colors to mix well along the way to the nozzle. The material of the adaptor can be plastic or metal as long as it is liquid sealed. The color flowing out from one-end of the adaptor is determined by relative flow rates of the three incoming materials, which are in three element colors. The flow speed from the one-end is a constant defined by users, no mater of which color the mixed material is flowing out. The flow rates of materials in three colors are may be summed up to a user-defined constant, and the ratios between them give the color of outflowing material. The distance between the adaptor and the extruding nozzle may be a controllable factor. When the path between the adaptor and the nozzle is short, the intervals between color changes are shorter but materials have less time to mix along the shorter pathway. On the other way, the color change intervals are larger with better mixing quality if the path between them is larger. The movements of building materials are driven by the plunger of the corresponding syringe during extrusion, whose bottom is fixed to a bar-shape component coupled to a threaded rod and a thin rod. In one embodiment, the bar has a hole for the rod and a hex nut embedded for coupling to threaded rod. The material used for the bar should be sufficiently strong to prevent bending as the bar moves along the rod. A bushing may be fixed in the hole to have a smoother motion of the bar along the thin rod. The bar and the plunger move along the vertical axis as the threaded rod is rotated by the stepper motor, which is capable of rotating by a small angle so the plunger moves incrementally, resulting in small volume of building material transported.

The printing process involves the print head of the nozzle, a support, and a radiation source. Building material, light curable resin may be provided from the nozzle droplet by droplet, and it starts to solidify as exposed to a radiation. The solidification rate is controlled so that a droplet is almost solidified when making a contact with the support or the object below but the material coming right out from the print head remains liquid so the head may not be obstructed by materials. The object is printed layer by layer: the nozzle may move horizontally in the X-Y plane to print material, and then the support may move downward along the z-axis by a thickness of a layer (a user defined factor) followed by a same printing process within the new X-Y plane.

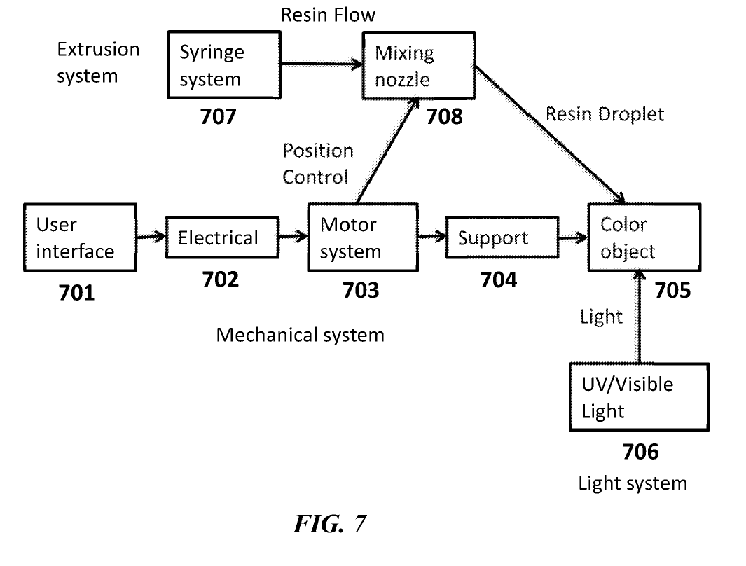

FIG. 7 shows an exemplary 3D color printing process. In FIG. 7, the schematic flow chart of the process to build color objects with the above embodiments is presented. The process may be facilitated by a 3D printing system. A user may initially provide input, such as a request to build a 3D object. The request may include one or more properties of the 3D object, such as material and/or color. The system may include a user interface 701 for receiving such request. The input for the user interface 701 can be a software interface on a computer/smartphone that can communicate with the system. Alternatively, the input for the user interface 701 may be a built-in interface to load data on portable storage devices, such as, for example, a SD card, a micro SD card, or a flash drive. Upon receiving the data from the user-end, the electrical system 702 may control the motor system 703. The motor system may comprise building material from a syringe system 707 that is moved to a mixer and nozzle system 708, so that the mechanical systems may transport building material from the cartridges to the nozzle and towards the support 704. Building material may also be directed as droplets 709 directly to form the colored three-dimensional object 705. The print head may be moving relative to the support while printing the three-dimensional object or a colored three-dimensional object 705. A UV light source, visible light source, or radiation source 706 may be used to solidify building material on the support is included in the light system. A mechanical system may comprise a user interface 701, electrical system 702, motor system 703, and support 704 to form a colored three-dimensional object 705. An extrusion system may comprise a syringe system 707, a

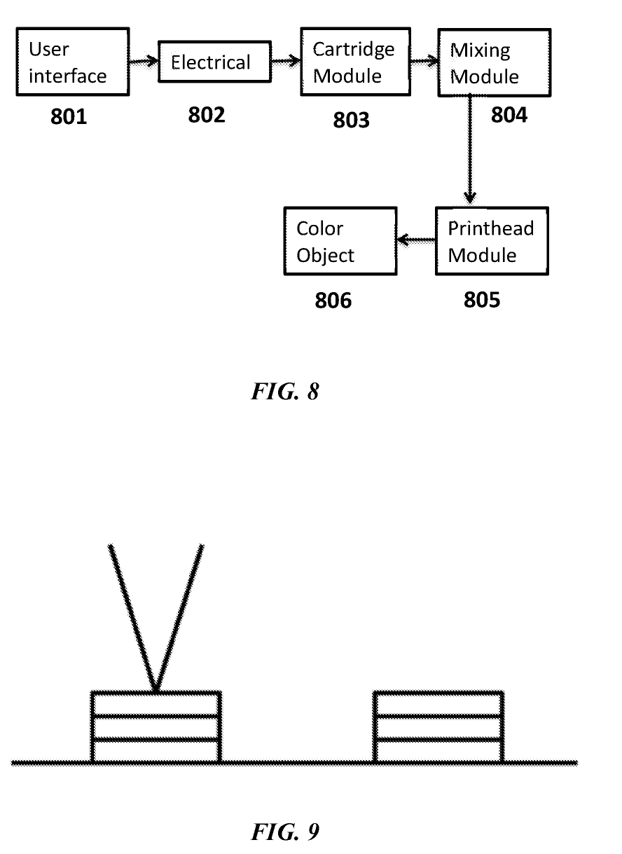

FIG. 8 is a schematic flow chart of a process to build color objects by applying a system described herein. A user uses a user interface 801 to input a design of a three-dimensional object. The input for the user interface 801 can be a software interface on a computer/smartphone that can communicate with the system. Alternatively, the input for the user interface 801 may be a built-in interface to load data on portable storage devices, such as, for example, a SD card, a micro SD card, or a flash drive. Upon receiving the data from the user interface 801, an electrical system 802 may control the movement of building material from the cartridge module 803 to the mixing module 804. The mixture may then be transported to the print head module 805 that directs the mixture towards a support to form a color three-dimensional object 806.

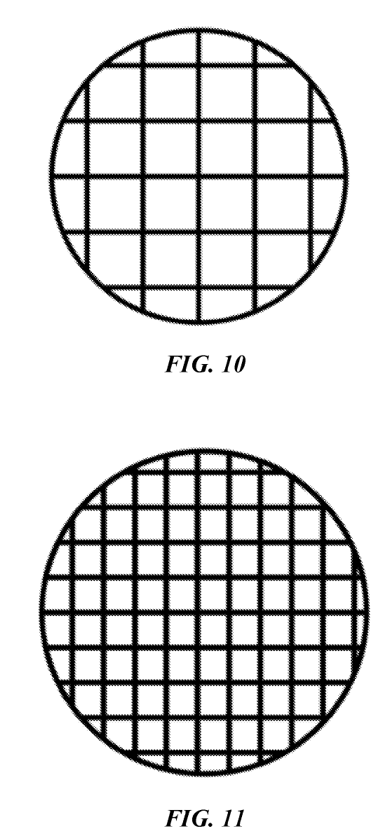

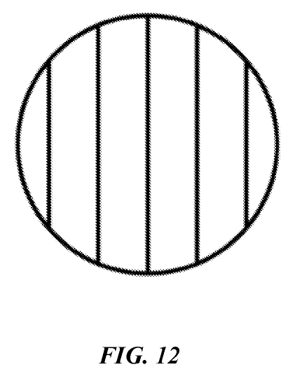

FIG. 9 is a schematic illustration of a general process of 3D printing. FIG. 10 provides a top cross-sectional view of a sphere of medium fill density, whereas FIG. 11 provides a top cross-sectional view of a sphere of high fill density. FIG. 12 provides a top cross-sectional view of a sphere.

Apparatuses, systems and methods of the present disclosure may be used to print anatomical models. The 3D printer can be loaded with digital file (*.STL, CT images, or others), and anatomical models can be constructed accordingly. Since the materials used in the system is soft and flexible, the printed models are more similar to real organs in terms of feeling, texture, and imaging results (such as ultrasonic imaging). The printed models can be used as educational tools, surgical simulation, or other medical applications.

An alternative application of the system is a multi-material 3D printer. Each cartridge can hold different building materials, so the printer can print objects with one of the materials in cartridges or a mixture of them (some or all materials). If the machine is used to print organ models, materials with various properties (such as densities, colors, or hardness) can be used to mimic an organ with several parts.

Each building material may be in solid, semi-solid or liquid. If solid or semi-solid building materials are used, such building materials may be melted prior to deposition adjacent to a support. Melting may be facilitated with the aid of one or more melting units, such as radiative (e.g., laser) and/or conductive (e.g., resistive heating) heating units.

A 3D extrusion printer can have a printing head with a nozzle for applying a build material as print; a filament stream supplied to the printing head to be melted and provide the build material, a coating unit upstream to the printing head on the filament stream; a fixing region located between the coating unit and the printing head; and a plurality of feed containers equipped with metering devices to supply a coating composition with one or more additives and an ink to the melted filament before entering the printing head. A mixing unit 12 can mix a liquid or liquefied (i.e., melted) composition prior to being fed to the print head. The printing head can be a static mixer in a lower region of the nozzle. The building material may not be colored. A building material may be non-transparent.

Feed containers with pigments containing color pigment in addition to black and to the inks and/or primary colors or additives. The pigments can be a metallic pigment or a fluorescent pigment can be used. Sensors can be provided to measure the flow of materials to the mixer and optimized with that information for color monitoring and print control.

In other embodiments, in place of the syringes, the system can use movable cartridges known for color printing such as for 2D color ink-jet printers, or involve feed vessels from which liquids are removed by pumping, or involve cartridges which can be clamped into a reciprocating pump. The design of these may be such that they can be replaced or renewed simply and individually.

The system can be used in an extrusion-based 3D printing is designed such that the respective color shade is input into a CAD program, and that a file is provided which comprises, in addition to the coordinates, the color information for the manufacturing process and for regulation of the formulation of materials and of colorants. An example of a suitable file format is described in Additive Manufacturing File Format (ASTM F2915-12). The respective color shade may be established by regulating the metering devices and by controlled metering of the respective primary colors and, respectively, black from the feed containers into the system.

Another embodiment works with Autodesk's Spark which connects digital information to 3D printers in a streamlined way, making it easier to visualize and optimize prints without trial and error, while broadening the range of materials used for printing. The system with Spark's software platform for 3D printing is enables interoperability of software, hardware and material suppliers. The Spark platform is open, so hardware manufacturers, app developers, product designers can use its building blocks to further push the limits of 3D printing.

The methods, apparatuses, and systems of the present disclosure may be used to form three-dimensional objects that may be used for various uses and applications. In some cases, uses and applications of three-dimensional objects include, but are not limited to, imitation skin objects for teaching, artificial skin for medical uses, making molds, flexible utensils, kitchen tools, silicon molds, rubber prototypes, and prosthetics for medical uses.

A computer may be used to regulate and control various aspects of the methods of the present disclosure, such as, for example, methods of producing the three-dimensional object, including, but not limited to, the movement of the support, movement of a building material applicator, and movement of a print head.

### Computer Control Systems

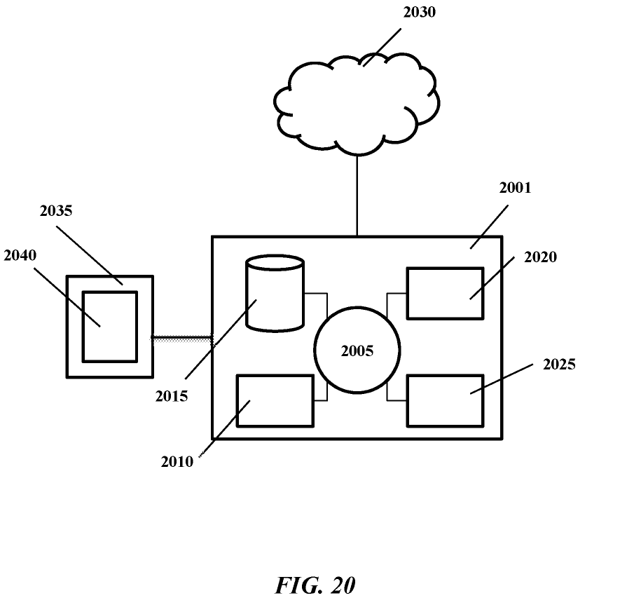

The present disclosure provides computer control systems that are programmed to implement methods of the disclosure. FIG. 20 shows a computer control system 2001 that is programmed or otherwise configured to produce a three-dimensional object. The computer control system 2001 can regulate various aspects of the methods of the present disclosure, such as, for example, methods of producing the three-dimensional object, including, but not limited to, the movement of the support, movement of a building material applicator, movement of a binding substance applicator, a cutting tool, and a heating tool. The computer control system 2001 can be implemented on an electronic device of a user or a computer system that is remotely located with respect to the electronic device. The electronic device can be a mobile electronic device.

The computer system 2001 includes a central processing unit (CPU, also “processor” and “computer processor” herein) 2005, which can be a single core or multi core processor, or a plurality of processors for parallel processing. The computer control system 2001 also includes memory or memory location 2010 (e.g., random-access memory, read-only memory, flash memory), electronic storage unit 2015 (e.g., hard disk), communication interface 2020 (e.g., network adapter) for communicating with one or more other systems, and peripheral devices 2025, such as cache, other memory, data storage and/or electronic display adapters. The memory 2010, storage unit 2015, interface 2020 and peripheral devices 2025 are in communication with the CPU 2005 through a communication bus (solid lines), such as a motherboard. The storage unit 2015 can be a data storage unit (or data repository) for storing data. The computer control system 2001 can be operatively coupled to a computer network (“network”) 2030 with the aid of the communication interface 2020. The network 2030 can be the Internet, an internet and/or extranet, or an intranet and/or extranet that is in communication with the Internet. The network 2030 in some cases is a telecommunication and/or data network. The network 2030 can include one or more computer servers, which can enable distributed computing, such as cloud computing. The network 2030, in some cases with the aid of the computer system 2001, can implement a peer-to-peer network, which may enable devices coupled to the computer system 2001 to behave as a client or a server.

The CPU 2005 can execute a sequence of machine-readable instructions, which can be embodied in a program or software. The instructions may be stored in a memory location, such as the memory 2010. The instructions can be directed to the CPU 2005, which can subsequently program or otherwise configure the CPU 2005 to implement methods of the present disclosure. Examples of operations performed by the CPU 2005 can include fetch, decode, execute, and writeback.

The CPU 2005 can be part of a circuit, such as an integrated circuit. One or more other components of the system 2001 can be included in the circuit. In some cases, the circuit is an application specific integrated circuit (ASIC).

The storage unit 2015 can store files, such as drivers, libraries and saved programs. The storage unit 2015 can store user data, e.g., user preferences and user programs. The computer system 2001 in some cases can include one or more additional data storage units that are external to the computer system 2001, such as located on a remote server that is in communication with the computer system 2001 through an intranet or the Internet.

The computer system 2001 can communicate with one or more remote computer systems through the network 2030. For instance, the computer system 2001 can communicate with a remote computer system of a user (e.g., a user controlling the manufacture of a three-dimensional object). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2001 via the network 2030.

Methods as described herein can be implemented by way of machine (e.g., computer processor) executable code stored on an electronic storage location of the computer system 2001, such as, for example, on the memory 2010 or electronic storage unit 2015. The machine executable or machine readable code can be provided in the form of software. During use, the code can be executed by the processor 2005. In some cases, the code can be retrieved from the storage unit 2015 and stored on the memory 2010 for ready access by the processor 2005. In some situations, the electronic storage unit 2015 can be precluded, and machine-executable instructions are stored on memory 2010.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 2001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

Methods and systems of the present disclosure can be implemented by way of one or more algorithms. An algorithm can be implemented by way of software upon execution by the central processing unit 2005. The algorithm can, for example, facilitate printing of a 3D object.

### EXAMPLES

### Example 1

Silicone building material was deposited into a material cartridge, and a second type of silicone building material is deposited into a second material cartridge. The building materials from the two material cartridges are mixed atmospheric temperature in a mixer. The mixture is directed through a nozzle towards a support. The mixture is directed towards the support to form a first layer of a three-dimensional object, wherein the first layer comprises a first perimeter and a first subsection of area within the first perimeter. The first subsection of area within the first perimeter is less than 99% of the area enclosed by the first perimeter.

A third type of silicone building material was deposited into a third material cartridge. Building material from the second and third material cartridges were mixed atmospheric temperature in a mixer. The mixture was directed through a nozzle towards the support to form a second layer of a three-dimensional object, wherein the second layer comprises a second perimeter and a second subsection of area within the second perimeter. The second subsection of area within the second perimeter was less than 99% of the area enclosed by the second perimeter, and at least a portion of the second subsection is adjacent to at least a portion of the first subsection.

Layers of building material were subsequently applied until the number of layers is equivalent to the number of cross-sections of the model design.

The hardness of the resulting three-dimensional object were altered by changing the fill density of the object without changing the building material. Three objects using the same silicon building material were formed with different fill densities, weight, and hardness properties, as shown in Table 1.

TABLE 1

| Sample | Fill Density | Weight | Hardness (Shore A) |
|---|---|---|---|
| 1 | 30% | 3.9 g | 10A |
| 2 | 60% | 6.2 g | 25A |
| 3 | 100% | 8.4 g | 30A |

### Example 2

A first type of silicone building material is deposited into a first material cartridge, and a second type of silicone building material is deposited into a second material cartridge. The building materials from the two material cartridges are mixed at atmospheric temperature in a mixer. The mixture is directed through a nozzle towards a 1 meter (m) by 1 m by 1 m support. The mixture is directed towards the support to form a first layer of a three-dimensional object, wherein the first layer comprises a first perimeter and a first subsection of area within the first perimeter. The first subsection of area within the first perimeter is less than 90% of the area enclosed by the first perimeter.

A third type of silicone building material is deposited into a third material cartridge. Building material from the second and third material cartridges are mixed atmospheric temperature in a mixer. The mixture is directed through a nozzle towards the support to form a second layer of a three-dimensional object, wherein the second layer comprises a second perimeter and a second subsection of area within the second perimeter. The second subsection of area within the second perimeter is less than 90% of the area enclosed by the second perimeter, and at least a portion of the second subsection is adjacent to at least a portion of the first subsection.

Layers of building material are subsequently applied until the number of layers is equivalent to the number of cross-sections of the model design.

After the desired number of layers is formed, the three-dimensional object is removed from the support as a final product.

Materials, devices, systems and methods herein, including building material compositions (e.g., building material layers), can be combined with or modified by other materials, devices, systems and methods, including material compositions, such as, for example, those described in U.S. Patent Publication No. 2015/0142159, which is entirely incorporated herein by reference.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-68. (canceled)

69. A method for forming a three-dimensional object, comprising:
(a) providing at least two material cartridges that are in fluid communication with a mixer that is in fluid communication with a nozzle of a print head, wherein said at least two material cartridges contain building materials;
(b) using building materials from said at least two material cartridges to generate a first mixture in said mixer;
(c) directing said first mixture from said mixer through said nozzle towards a support to form a first layer of said three-dimensional object adjacent to said support, wherein said first layer comprises a first perimeter and a first subsection of area within said first perimeter;
(d) using building materials from said at least two material cartridges to generate a second mixture in said mixer; and
(e) directing said second mixture from said mixer through said nozzle towards said support to form a second layer of said three-dimensional object adjacent to said support, wherein said second layer comprises a second perimeter and a second subsection of area within said second perimeter, wherein at least a portion of said second subsection is adjacent to at least a portion of said first subsection.

70. The method of claim 69, further comprising repeating (d)-(e) at least 10 times.

71. The method of claim 69, wherein said first subsection is less than 99% of an area enclosed by said first perimeter.

72. The method of claim 69, wherein at least one of said building materials comprises silicone, silicone rubber, polyurethane, fluoroelastomer, acrylic paste, an epoxy resin, or a combination thereof.

73. The method of claim 69, wherein at least one of said building materials has a viscosity less than or equal to 10,000,000 centipoise (cP).

74. The method of claim 69, wherein at least one of said building materials is in a liquid state.

75. The method of claim 69, wherein said building materials are directed to said nozzle by mechanical force, pneumatic force, gravity, osmotic pressure difference, pressure difference, or a combination thereof.

76. The method of claim 69, wherein said print head moves to said first subsection relative to said support.

77. The method of claim 69, wherein said nozzle moves over said first subsection within said first perimeter without directing said building materials towards said support.

78. The method of claim 69, wherein said three-dimensional object is anisotropic.

79. The method of claim 69, wherein said three-dimensional object is isotropic.

80. The method of claim 69, wherein said first layer of said three-dimensional object and said second layer of said three-dimensional object have at least one physical property that is different.

81. The method of claim 69, wherein said first subsection is in accordance with a model design of said three-dimensional object.

82. The method of claim 69, wherein at least one of said building materials comprises a polymer.

83. The method of claim 69, wherein upon forming said second layer, a cross-section of said three-dimensional object is not 100% filled.

84. The method of claim 69, wherein along a cross-section, said three-dimensional object has multiple regions of different fill densities.

85. The method of claim 69, wherein said three-dimensional object has a fill density that is isotropic.

86. The method of claim 69, wherein said three-dimensional object has a fill density that is anisotropic.

87. The method of claim 69, further comprising filling a cavity of said three-dimensional object.

88. The method of claim 87, wherein said cavity is filled at a fill rate that is selected to provide a predetermined physical property of said three-dimensional object.

89. The method of claim 88, wherein said predetermined physical property is one or more of hardness, density, tensile strength and elongation-to-break.
